(19) United States
(12) Patent Application Publication
(10) Pub. No.: US 2026/0264042 A1
(43) Pub. Date: Sep. 10, 2026

(54) DEVICE FOR OPTICAL OBSERVATION AND STRUCTURAL ANALYSIS OF HYDRATE CRYSTAL GROWTH

(71) Applicant: DALIAN UNIVERSITY OF TECHNOLOGY, Dalian (CN)

(72) Inventors: Lanlan JIANG, Dalian (CN); Yongchen SONG, Dalian (CN); Yingying LIU, Dalian (CN); Lintao SUN, Dalian (CN); Mingjun YANG, Dalian (CN); Tao YU, Dalian (CN); Yi ZHANG, Dalian (CN); Bingbing CHEN, Dalian (CN); Lei YANG, Dalian (CN); Lunxiang ZHANG, Dalian (CN)

(21) Appl. No.: 19/275,003

(22) Filed: Jul. 21, 2025

(30) Foreign Application Priority Data
Mar. 4, 2025 (CN) 202510248973.5

(51) Int. Cl. B01J 19/12; B01J 19/00; B01J 19/26

(52) U.S. Cl. CPC B01J 19/121; B01J 19/0073; B01J 19/26

(57) ABSTRACT

A device for optical observation and structural analysis of hydrate crystal growth comprises a capillary reaction kettle, a gas injection system, a detection system, a temperature control system and a data acquisition system. Visual windows are arranged at top and bottom of the capillary reaction kettle, and a high-pressure capillary is arranged inside the capillary reaction kettle. One end of the capillary reaction kettle is connected with the gas injection system and is controlled by a gas cylinder, a pressure regulating gauge and a high-pressure plunger pump together. The corresponding position of the top visual window of the capillary reaction kettle comprises a Raman observation system for observing and recording the crystal structure of a hydrate. The internal temperature of the capillary reaction kettle is controlled by an upper cover, a main body and an internal low-temperature circulation cavity.

### TECHNICAL FIELD

The present disclosure belongs to the technical field of energy scientific research instruments and particularly relates to a device for optical observation and structural analysis of hydrate crystal growth.

### BACKGROUND

Hydrates are a class of clathrate compounds formed by water molecules and guest molecules through weak intermolecular forces and are generally generated under low-temperature and high-pressure conditions. Due to the characteristics of higher gas storage density and cleanness and environmental protection, in recent years, the research and application of hydrate technology in the fields of carbon dioxide emission reduction, cold energy storage, seawater desalination and the like are greatly developed. However, to further advance the practical application of the hydrate technology, it is essential to investigate the hydrate crystal formation and crystal structure intensively.

The research on hydrate crystals has important significance for understanding the formation mechanism and the kinetic properties of the hydrate crystals. The formation process of the hydrate mainly involves complex processes such as gas-liquid diffusion and phase state conversion, and the processes are not only influenced by external conditions (such as temperature and pressure) but are also closely related to the types of the guest molecules, etc. As a typical pore medium, capillary can effectively simulate the formation process of the hydrate and study the growth behavior of the crystals therein. Meanwhile, the influence of the confined space in the capillary on the growth of the hydrate has obvious research value, and the morphology and stability of the hydrate crystals can be deeply researched.

In the research of the hydrate crystals, Raman spectroscopy technology and optical microscopy technology are two indispensable experimental means. Raman spectroscopy is a nondestructive testing technology based on molecular vibrations and can provide detailed information about molecular structures, chemical bonds, and crystal composition. For example, the Raman spectroscopy can detect interaction between water molecules and gas molecules in the hydrate crystals, and research the stability, formation kinetics and phase change process of the hydrates. The optical microscopy technology can be used for visually observing the morphology, size and growth dynamics of the hydrate crystals, and provides high-resolution image support for researching the microscopic behaviours of the hydrate. The two technologies each have advantages in hydrate research, but in the current experiments, the two technologies are usually performed by depending on independent equipment, and the observation by using the same equipment is difficult to realize. In the traditional experiment, an optical microscope is mainly used for recording the morphological change of the growth of the hydrate crystals, and a Raman spectrometer is used for analysing the molecular structure and composition information. Because the operating principles and optical designs of the two equipment are different, equipment that satisfy both of the two functions are rare. The separated experimental method not only increases the complexity of experimental operation, but also limits the real-time joint observation capability of the growth and the structural change of the hydrate crystals, and cannot meet the requirements of comprehensive research on a dynamic process and local characteristics.

### SUMMARY

In order to solve the existing problems of observation in the existing technology, the present disclosure provides a device for optical observation and structural analysis of hydrate crystal growth. The device not only has scientific research and teaching values, but also has technical application potential, and is beneficial to improving the practical application and development of the hydrate technology in various fields.

The present disclosure adopts the following technical solution: a device for optical observation and structural analysis of hydrate crystal growth, including a capillary reaction kettle, a gas injection system, a detection system, a temperature control system and a data acquisition system, wherein
the capillary reaction kettle includes a reaction kettle main body and a reaction kettle upper cover, and the reaction kettle upper cover is provided with an upper cover low-temperature circulation cavity;
the outer side of the reaction kettle main body adopts a main body low-temperature circulation cavity, and the interior of the reaction kettle main body includes a transmission region and a capillary fixing region; a main body driver in the transmission region penetrates through the side wall of the reaction kettle main body and is connected with a gas injection pipe fixing table, the gas injection pipe fixing table is sleeved on one ends of transmission rods, the other ends of the transmission rods are fixed on a capillary fixing table, and springs are sleeved on outside of the transmission rods; and a gas injection pipe is fixed in a gas injection pipe fixation groove of the gas injection pipe fixing table through a gas injection pipe fixing pressing sheet;
in the capillary fixing region, the capillary fixing table and an internal low-temperature circulation cavity are fixed on the reaction kettle main body, one end of a high-pressure capillary is a sealed end, the other end of the high-pressure capillary is an open end, and the open end is connected with the gas injection pipe;
the open end is supported by a fixing table clamping groove of the capillary fixing table, the sealed end is pressed in a circulation cavity clamping groove through a capillary visual pressing sheet fixed in the internal low-temperature circulation cavity, and the capillary visual pressing sheet is provided with aobservation notch for observing the high-pressure capillary;
when the main body driver enables the gas injection pipe fixing table to move, the gas injection pipe moves along with the gas injection pipe fixing table, such that the high-pressure capillary moves in the fixing table clamping groove and the circulation cavity clamping groove;
the reaction kettle upper cover and the reaction kettle main body are both provided with visual windows for light transmission or observation, and the high-pressure capillary at theobservation notch is located in a light transmission or observation region of the visual window;
the gas injection system is connected to the high-pressure capillary of the capillary reaction kettle;
the detection system is used for performing Raman detection or optical detection of the capillary reaction kettle; and
the temperature control system communicates with the upper cover low-temperature circulation cavity, the main body low-temperature circulation cavity and the internal low-temperature circulation cavity of the capillary reaction kettle.

A low-temperature circulation outlet pipe of a low-temperature constant-temperature tank in the temperature control system is connected to the upper cover low-temperature circulation cavity through an upper cover low-temperature circulation cavity inlet, an upper cover low-temperature circulation cavity outlet is connected to the main body low-temperature circulation cavity through a main body low-temperature circulation cavity inlet, a main body low-temperature circulation cavity outlet is connected to the internal low-temperature circulation cavity through an internal low-temperature circulation cavity main inlet and an internal low-temperature circulation cavity inlet in sequence; and an internal low-temperature circulation cavity outlet is connected with an internal low-temperature circulation cavity main outlet and then connected back to the low-temperature constant-temperature tank through a low-temperature circulation inlet pipe.

The gas injection system includes a gas cylinder, which is connected to a high-pressure plunger pump through a pressure regulating gauge and a first stop valve, and a high-pressure pipeline of the high-pressure plunger pump is provided with a second stop valve and a third stop valve; and the tail end of the high-pressure pipeline is the gas injection pipe connected with the high-pressure capillary.

The temperature control system includes a low-temperature constant-temperature tank, a low-temperature circulation inlet pipe and a low-temperature circulation outlet pipe; and the low-temperature circulation inlet pipe is connected with an internal low-temperature circulation cavity main outlet, and a low-temperature circulation outlet pipe is connected with an upper cover low-temperature circulation cavity inlet.

The detection system includes a microscopic camera, a camera support, a detection auxiliary part and an optical movable platform; the detection auxiliary part, the microscopic camera and the camera support are all arranged on the optical movable platform; and the detection auxiliary part adopts a stainless steel sheet during Raman detection, and the detection auxiliary part adopts a light source during optical detection.

The data acquisition system includes an image acquisition system and a temperature acquisition system, and a microscopic camera in the image acquisition system is connected to a data acquisition computer through a camera transmission line; and a temperature sensor in the temperature acquisition system is connected to the data acquisition computer through a data acquisition box.

A top visual window is fixed on the reaction kettle upper cover through a top visual window fixing ring, and a bottom visual window is fixed on the reaction kettle main body through a bottom visual window fixing ring.

The reaction kettle upper cover of the capillary reaction kettle is fixed with the reaction kettle main body through bolts, and a polytetrafluoroethylene sealing ring is arranged in a sealing ring placing notch on the reaction kettle main body.

The bottom of the reaction kettle main body is provided with a reaction kettle fixing block fixed on the optical movable platform during Raman detection, and the reaction kettle fixing block is provided with reaction kettle fixing threaded rods, and the number of the reaction kettle fixing threaded rods is four.

Beneficial effects of the present disclosure: the device includes a capillary reaction kettle, a gas injection system, a detection system, a temperature control system and a data acquisition system. The capillary reaction kettle is a sealed normal-pressure container and can be internally provided with the high-pressure capillary, and visible sapphire windows are arranged at both the t op and the bottom of the capillary reaction kettle; one end of the capillary reaction kettle is connected with the gas injection system and is controlled by a gas cylinder, a pressure regulating gauge and a high-pressure plunger pump together; the corresponding position of the top visual window of the capillary reaction kettle includes a Raman observation system for observing and recording the crystal structure of a hydrate, under non-Raman detection condition, the Raman observation system can be equally replaced by a microscopic imaging system for monitoring the morphologic change of hydrate crystal growth in real time; the temperature control system is used for controlling the internal temperature of the capillary reaction kettle, and temperature data is obtained by measuring through a temperature sensor; and the data acquisition system records temperature data, Raman spectra or optical images in real time. The device can realize Raman or optical in-situ observation of the full-period change of the hydrate crystal growth in the capillary.

The micro-Raman device of the present disclosure is unique in design, can be used for Raman spectroscopy detection and optical microscopy observation. But it should be emphasized that the two functions are not simultaneously performed, but are flexibly switched between different modes through a set of equipment. The present disclosure has the following beneficial effects. Firstly, the present disclosure realizes the effective integration of the two functions of Raman spectroscopy and optical microscopy in a set of devices through integrated design. Researchers can quickly switch modes according to experimental requirements and avoid complex operation for replacing equipment in the traditional method. Furthermore, the device can adapt to different experimental requirements by providing an independent optical observation mode and a Raman detection mode. Finally, the device can efficiently complete tasks no matter the accurate measurement of molecular vibration characteristics in Raman spectroscopy detection or the high-resolution imaging of optical microscopy technology on crystal morphology, and is suitable for hydrate formation, crystal growth research and other various experimental scenes.

The device can realize the optical microscopy and Raman spectroscopy observation in the same equipment. The device is suitable for two experimental backgrounds of optical observation and Raman observation, and has optical observation conditions and simultaneously Raman spectroscopy experimental characteristics, thereby really realizing the purpose of “one set of devices having two applications”. The device not only significantly improves the experimental efficiency and reduces the experimental cost, but also provides more comprehensive data support for the research of hydrate crystals. The application of the device provides a powerful tool support for the in-depth research of the growth mechanism, the phase change process and the structural characteristics of the hydrate crystals, and at the same time lays a solid scientific foundation for the development and popularization of the hydrate technology.

### BRIEF DESCRIPTION OF THE DRAWINGS

FIG. 1 is a schematic diagram of a device for optical observation and structural analysis of hydrate crystal growth;

FIG. 2 is a perspective view (front view) of a capillary reaction kettle;

FIG. 3 is a perspective view (back view) of the capillary reaction kettle;

FIG. 4 is a front view of the capillary reaction kettle;

FIG. 5 is a front view of a reaction kettle main body;

FIG. 6 is a perspective view of the reaction kettle main body; and

FIG. 7 is a perspective view of the interior of the reaction kettle main body.

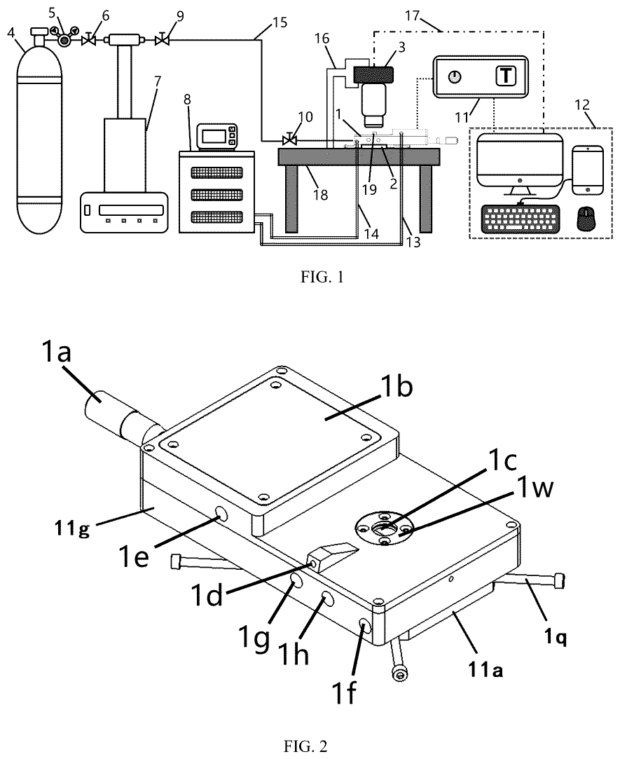

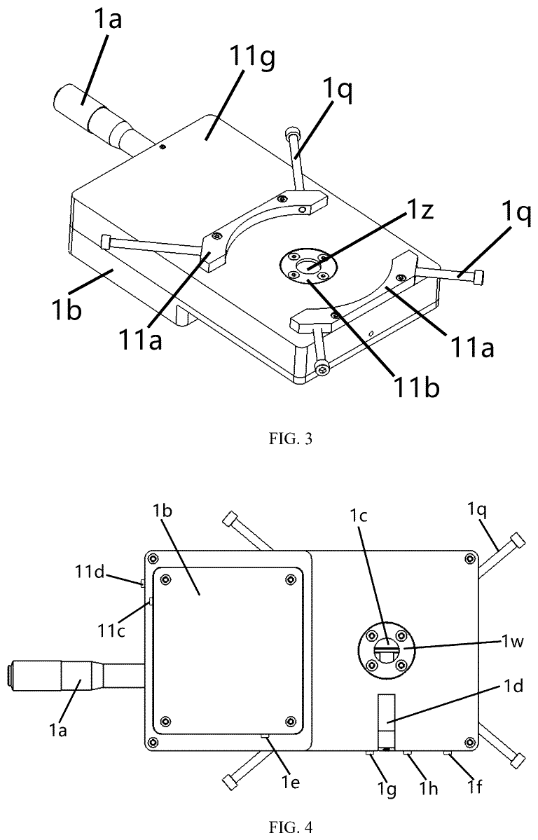

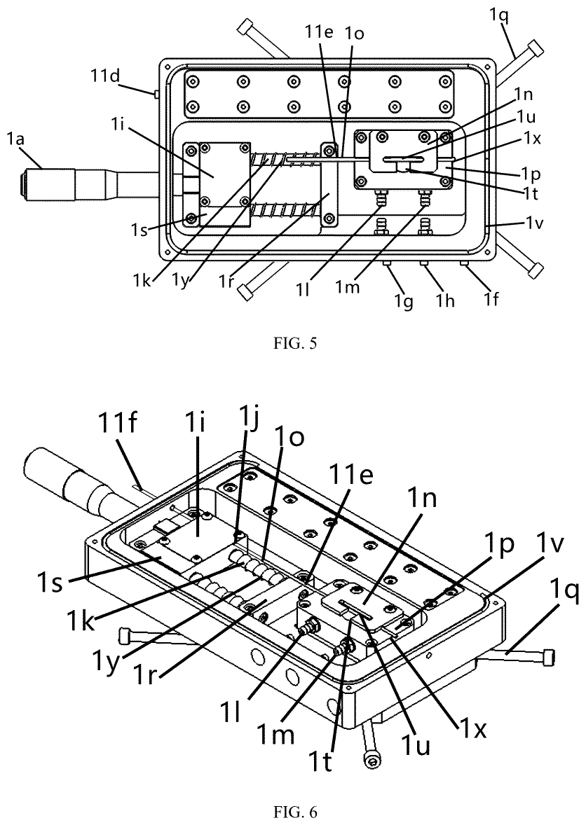

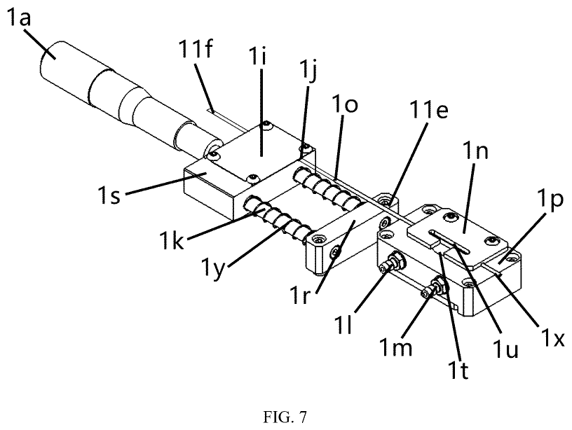

In the figures: 1, capillary reaction kettle; 2, detection auxiliary part; 3, microscopic camera; 4, gas cylinder; 5, pressure regulating gauge; 6, first stop valve; 7, high-pressure plunger pump; 8, low-temperature constant-temperature tank; 9, second stop valve; 10, third stop valve; 11, data acquisition box; 12, data acquisition computer; 13, low-temperature circulation outlet pipe; 14, low-temperature circulation inlet pipe; 15, high-pressure pipeline; 16, camera support; 17, camera transmission line; 18, optical movable platform; 19, temperature sensor; 1a, main body driver; 1b, upper cover low-temperature circulation cavity; 1c, top visual window; 1d, temperature sensor connecting port; 1e, upper cover low-temperature circulation cavity outlet; 1f, main body low-temperature circulation cavity outlet; 1g, internal low-temperature circulation cavity main inlet; 1h, internal low-temperature circulation cavity main outlet; 1i, gas injection pipe fixing pressing sheet; 1j, gas injection pipe fixation groove; 1k, transmission rod; 1l, internal low-temperature circulation cavity inlet; 1m, internal low-temperature circulation cavity outlet; 1n, capillary visual pressing sheet; 1o, high-pressure capillary; 1p, internal low-temperature circulation cavity; 1q, reaction kettle fixing threaded rod; 1r, capillary fixing table; 1s, gas injection pipe fixing table; 1t, temperature sensor clamping groove; 1u, observation notch; 1v, sealing ring placing notch; 1w, top visual window fixing ring; 1x, circulation cavity clamping groove; 1y, spring; 1z, bottom visual window; 11a, reaction kettle fixing block; 11b, bottom visual window fixing ring; 11c, upper cover low-temperature circulation cavity inlet; 11d, main body low-temperature circulation cavity inlet; 11e, fixing table clamping groove; 11f, gas injection pipe; and 11g, main body low-temperature circulation cavity.

### DETAILED DESCRIPTION OF THE EMBODIMENTS

The content of the present disclosure will be further described in detail below with reference to the drawings and specific embodiments.

A micro-Raman device for optical observation and structural analysis of hydrate crystal growth, including a capillary reaction kettle 1, a gas injection system, a detection system, a temperature control system and a data acquisition system.

The gas injection system includes a gas cylinder 4, a pressure regulating gauge 5, a high-pressure pipeline 15 and a high-pressure plunger pump 7. An outlet end of the pressure regulating gauge 5 is provided with a first stop valve 6. An outlet end of the high-pressure plunger pump 7 is provided with a second stop valve 9 and a third stop valve 10.

The detection system includes a microscopic camera 3, a camera support 16, a detection auxiliary part 2 and an optical movable platform 18. The light source or stainless steel sheet, the microscopic camera 3 and the camera support 16 are all arranged on the optical movable platform 18. The selection of the detection auxiliary part 2 is based on different test purposes.

The temperature control system includes a low-temperature constant-temperature tank 8, a low-temperature circulation inlet pipe 14 and a low-temperature circulation outlet pipe 13. The low-temperature circulation inlet pipe 14 is connected with a main body low-temperature circulation cavity outlet 1f. The low-temperature circulation outlet pipe 13 is connected with an upper cover low-temperature circulation cavity inlet 11c.

The data acquisition system includes a Raman spectrum or optical image acquisition system and a temperature acquisition system. The Raman spectrum or optical image acquisition system includes the microscopic camera 3, a camera transmission line 17 and a data acquisition computer 12. The temperature acquisition system includes a temperature sensor 19, a data acquisition box 11 and a data acquisition computer 12.

An outlet pipeline of the gas cylinder 4 in the gas injection system is provided with the pressure regulating gauge 5 and the first stop valve 6, and the outlet pipeline of the gas cylinder 4 is connected to the high-pressure plunger pump 7. An outlet of the high-pressure plunger pump 7 is provided with the high-pressure pipeline 15 and the high-pressure pipeline 15 is provided with the second stop valve 9 and the third stop valve 10. An end part of the high-pressure pipeline 15 is a gas injection pipe 11f and the gas injection pipe 11f is connected to the capillary reaction kettle 1.

In the temperature control system, the low-temperature circulation inlet pipe 14 of the low-temperature constant-temperature tank 8 is connected with the main body low-temperature circulation cavity outlet 1f of the capillary reaction kettle 1; and the low-temperature circulation outlet pipe 13 is connected with the upper cover low-temperature circulation cavity inlet 11c of the capillary reaction kettle 1.

The capillary reaction kettle 1 is arranged on the optical movable platform 18. The microscopic camera 3 is arranged above the capillary reaction kettle 1 through the camera support 16. The detection auxiliary part 2 is arranged under the capillary reaction kettle 1. The detection auxiliary part 2 adopts a stainless steel sheet during Raman detection and the detection auxiliary part 2 adopts a light source during optical detection.

The capillary reaction kettle 1 includes a reaction kettle main body and a reaction kettle upper cover, and the reaction kettle upper cover is provided with an upper cover low-temperature circulation cavity 1b.

A main body low-temperature circulation cavity 11g is arranged at the outer side of the reaction kettle main body, and the interior of the reaction kettle main body includes a transmission region and a capillary fixing region. A main body driver 1a in the transmission region passes through the side wall of the reaction kettle main body and is connected with a gas injection pipe fixing table 1s, the gas injection pipe fixing table 1s is sleeved on one ends of transmission rods 1k, the other ends of the transmission rods 1k are fixed on a capillary fixing table 1r, and the capillary fixing table 1r is fixed on the reaction kettle main body. Springs 1y are sleeved outside the transmission rods 1k, and the gas injection pipe 11f passes through the side wall of the reaction kettle main body and is fixed in a gas injection pipe fixation groove 1j of the gas injection pipe fixing table 1s through a gas injection pipe fixing pressing sheet 1i; and when the main body driver 1a acts inward, the gas injection pipe fixing table 1s is driven to move inward along the transmission rods 1k and compress the springs 1y, and the gas injection pipe fixing table 1s drives the gas injection pipe 11f to move inward. Similarly, when the main body driver 1a acts outward, the springs 1y are extended to move the gas injection pipe fixing table 1s outward along the transmission rods 1k, and the gas injection pipe fixing table 1s drives the gas injection pipe 11f to move outward.

One end of a high-pressure capillary 1o is a sealed end, the other end of the high-pressure capillary is an open end, and the open end of the high-pressure capillary 1o is connected with the gas injection pipe 11f.

In the capillary fixing region, the capillary fixing table 1r and an internal low-temperature circulation cavity 1p are fixed on the reaction kettle main body, and the high-pressure capillary 1o is arranged in a fixing table clamping groove 11e of the capillary fixing table 1r and a circulation cavity clamping groove 1x of the internal low-temperature circulation cavity 1p; and a capillary visual pressing sheet 1n is fixed on the internal low-temperature circulation cavity 1p and presses the high-pressure capillary 1o in the circulation cavity clamping groove 1x, and the capillary visual pressing sheet 1n is provided with aobservation notch 1u for observing the high-pressure capillary 1o.

When the main body driver 1a enables the gas injection pipe fixing table 1s to move, the gas injection pipe 11f moves along with the gas injection pipe fixing table 1s, such that the high-pressure capillary 1o moves in the fixing table clamping groove 11e and the circulation cavity clamping groove 1x.

A low-temperature circulation structure is arranged in the capillary reaction kettle, and the upper cover low-temperature circulation cavity 1b and the main body low-temperature circulation cavity 11g communicate with the internal low-temperature circulation cavity 1p.

An outlet of the low-temperature constant-temperature tank 8 in the temperature control system is connected to the upper cover low-temperature circulation cavity 1b through an upper cover low-temperature circulation cavity inlet 11c, an upper cover low-temperature circulation cavity outlet 1e is connected to the main body low-temperature circulation cavity 11g through a main body low-temperature circulation cavity inlet 11d, a main body low-temperature circulation cavity outlet 1f is connected to the internal low-temperature circulation cavity 1p through an internal low-temperature circulation cavity main inlet 1g and an internal low-temperature circulation cavity inlet 1l in sequence; and an internal low-temperature circulation cavity outlet 1m is connected with an internal low-temperature circulation cavity main outlet 1h and then connected back to an inlet of the low-temperature constant-temperature tank 8.

The reaction kettle upper cover and the reaction kettle main body are both provided with visual windows for light transmission or observation, and the high-pressure capillary 1o at theobservation notch 1u is located in a light transmission or observation region of the visual window; the detection system is used for performing Raman detection or optical detection microscopic imaging of the capillary reaction kettle 1; and
a top visual window 1c is fixed on the reaction kettle upper cover through a top visual window fixing ring 1w, and a bottom visual window 1z is fixed on the reaction kettle main body through a bottom visual window fixing ring 11b.

The reaction kettle upper cover of the capillary reaction kettle 1 is fixed with the reaction kettle main body through bolts, and a polytetrafluoroethylene sealing ring is arranged in a sealing ring placing notch 1v in the reaction kettle main body.

The bottom of the reaction kettle main body is provided with a reaction kettle fixing block 11a fixed on the optical movable platform 18 during Raman detection, the reaction kettle fixing block 11a is provided with reaction kettle fixing threaded rods 1q, and the number of the reaction kettle fixing threaded rods is four.

The Raman observation or microscopic imaging platform includes the capillary visual pressing sheet 1n and the internal low-temperature circulation cavity 1p. The capillary visual pressing sheet 1n is provided with theobservation notch 1u matched with the diameter of the top visual window 1c and a temperature sensor clamping groove 1t corresponding to a temperature sensor connecting port 1d. The internal low-temperature circulation cavity 1p is provided with the circulation cavity clamping groove 1x with the same diameter as that of the high-pressure capillary 1o.

The optical movable platform 18 adopts an aluminium alloy framework, and the capillary reaction kettle 1 and the high-pressure pipeline 15 are both made of stainless steel materials. The gas injection pipe fixation groove 1j, the gas injection pipe fixing pressing sheet 1i and the capillary visual pressing sheet 1n ensure that the high-pressure capillary 1o is on the same horizontal line. The top visual window 1c has the same bottom visual window 1z at the corresponding position at bottom. During Raman detection, the detection auxiliary part 2 corresponding to the bottom of the capillary reaction kettle 1 is a stainless steel sheet, so as to prevent Raman laser penetration leading to that the structure of hydrate crystals cannot be identified. During optical detection, the detection auxiliary part 2 corresponding to the bottom of the capillary reaction kettle 1 is a light source, so as to facilitate shooting of the morphologic change of hydrate crystals.

The upper cover and the main body part of the capillary reaction kettle 1 are fixedly connected with stainless steel screws. In order to ensure the airtightness of the reaction kettle, the polytetrafluoroethylene sealing ring is arranged in the sealing ring placing notch 1v in the reaction kettle main body. The top visual window fixing ring 1w, the upper cover low-temperature circulation cavity 1b, the gas injection pipe fixing pressing sheet 1i, the gas injection pipe fixing table 1s, the capillary fixing table 1r, the capillary visual pressing sheet 1n and the internal low-temperature circulation cavity 1p are all fixed by the stainless steel screws. The reaction kettle fixing block 11a on the back of the reaction kettle main body is fixed on the optical movable platform 18 when used for Raman detection, and the reaction kettle fixing block 11a is provided with four reaction kettle fixing threaded rods 1q.

The device for optical observation and structural analysis of hydrate crystal growth is used in the observation of the growth process of carbon dioxide gas hydrate crystals at 2° C. and 3.5 M Pa. The use method is described. Carbon dioxide gas used in the experiment is from Dalian Special Gas Co., Ltd. and has a purity of not lower than 99.9%. The water used to form the carbon dioxide hydrate is deionized water and is prepared by a laboratory deionized water machine.

The general working process is divided into the following two links according to the time sequence: device assembly and airtightness test, and crystal sample preparation and observation.

### Example 1

Taking the optical observation of the growth process of carbon dioxide hydrate crystals as an example, the specific embodiment is as follows:
in the link of device assembly and airtightness test, firstly, the connection of a high-pressure pipeline was completed, specifically, a gas cylinder 4, a pressure regulating gauge 5, a first stop valve 6, a high-pressure plunger pump 7, a second stop valve 9 and a third stop valve 10 were connected in sequence through the high-pressure pipeline 15. An open end of a high-pressure capillary 1o was connected with the high-pressure pipeline 15 to form a complete passage. In the connection process, the high-pressure gas injection pipeline was carefully clamped in a gas injection pipe fixation groove 1j and a gas injection pipe fixing pressing sheet 1i.

Meanwhile, the capillary was fixed in a transmission region through a capillary fixing table 1r, a capillary visual pressing sheet 1n and a circulation cavity clamping groove 1x. Then the construction of a capillary reaction kettle 1 was completed, and a temperature sensor 19 was arranged in a temperature sensor connecting port 1d. A sealing ring was arranged in a sealing ring placing notch 1v, and a reaction kettle upper cover was tightly connected with a reaction kettle main body by utilizing a bolt structure. A wipe-clean top visual window 1c was arranged on the capillary reaction kettle upper cover, and the top visual window 1c was fixed by a top visual window fixing ring 1w which was fixed by bolts. According to the same steps, a bottom visual window fixing ring 11b was used to fix a bottom visual window 1z.

After the installation was finished, nitrogen gas with the pressure of 3.5 MPa was injected into the high-pressure capillary 1o through the high-pressure plunger pump 7, and the high-pressure plunger pump 7 was set to be in a constant pressure mode. Whether the indicated number of the gas volume in the pump was reduced within 12 hours was observed. If no reduction, the system was proved to have good airtightness, and the next process was continuously performed. If there was a reduction, all connecting parts of the system were checked by means of leakage detection until the indicated number of the volume was unchanged.

In the link of crystal sample preparation and observation, firstly, nitrogen gas for leakage detection was replaced with high-purity carbon dioxide gas for experiments. According to the volume of deionized water required by the experiment, the deionized water prepared in a laboratory was injected into the high-pressure capillary 1o by a micro-injector. The high-pressure capillary was arranged in the capillary reaction kettle 1 according to the device assembly process. Then a microscopic camera 3 was connected to a data acquisition computer 12 through a camera transmission line 17. The temperature sensor 19 was connected to a data acquisition box 11 and connected to a data acquisition computer 12.

Adjustment of position of high-pressure capillary 1o: to ensure that the hydrate formation process was successfully observed and that the final hydrate sample was as centered as possible in the field of view, a deionized water level needed to be adjusted to a suitable position before the experiment starts. When a main body driver 1a acted inward, a gas injection pipe fixing table 1s was driven to move inward along transmission rods 1k and compressed springs 1y, and the gas injection pipe fixing table 1s drived a gas injection pipe 11f to move inward, thereby driving the high-pressure capillary 1o to move inward. Similarly, when the main body driver 1 a acted outward, the springs 1y were extended to make the gas injection pipe fixing table 1s move outward along the transmission rods 1k, and the gas injection pipe fixing table 1s drived the gas injection pipe 11f to move outward, thereby driving the high-pressure capillary 1o to move outward.

In optical detection, a light source was arranged at a position below the bottom visual window 1z. Then a low-temperature circulation outlet pipe 13 was connected with an upper cover low-temperature circulation cavity inlet 11c, and a main body low-temperature circulation cavity outlet 1f was connected with a low-temperature circulation inlet pipe 14. A low-temperature constant-temperature tank 8 was turned on, the temperature of the capillary reaction kettle 1 was maintained at 2° C. and stabilized for 30 min, and then the experiment was started. During the period, the temperature in the capillary reaction kettle 1 was observed through the temperature sensor 19, and the set temperature of the low-temperature constant-temperature tank 8 was adjusted to reach the temperature required by the experiment. Then high-pressure carbon dioxide gas was injected to generate a carbon dioxide hydrate sample. The gas cylinder 4 was opened, the pressure regulating gauge 5 was adjusted to a proper pressure, the first stop valve 6 was opened, the second stop valve 9 was closed, and the high-pressure carbon dioxide gas in the gas cylinder 4 was injected into the high-pressure plunger pump 7. After a certain time, the first stop valve 6 was closed, the second stop valve 9 was opened, the pressure value was set, and 3.5 MPa was maintained in a constant pressure mode. After the pressure and the temperature were stable, the light source was turned on and adjusted to the proper brightness, the microscopic camera 3 was adjusted to a proper and clear shooting angle, a data recording module of the data acquisition computer 12 was turned on, and meanwhile, the temperature data and the image data were recorded. The third stop valve 10 was opened, and the high-pressure carbon dioxide gas was injected into the high-pressure capillary 1o. The indicated number of the pressure of the high-pressure plunger pump 7 was observed. After the pressure was stabilized at 3.5 MPa, the third stop valve 10, the second stop valve 9 and the high-pressure plunger pump 7 were closed. Finally, the growth process of the carbon dioxide hydrate crystals was optically observed and recorded.

### Example 2

Taking Raman measurement of the growth structure of carbon dioxide hydrate crystals as an example, the specific embodiment is as follows: in the link of device assembly and airtightness test, this embodiment was totally the same as that of the optical observation of the growth process of the carbon dioxide hydrate crystals.

In the link of crystal sample preparation and observation: adjustment of position of high-pressure capillary 1o: to ensure that the final hydrate sample was as centered as possible in the field of view, a deionized water level needed to be adjusted to a suitable position before the experiment starts. When a main body driver 1a acted inward, a gas injection pipe fixing table 1s was driven to move inward along transmission rods 1k and compressed springs 1y, and the gas injection pipe fixing table 1s drived a gas injection pipe 11f to move inward, thereby driving the high-pressure capillary 1o to move inward. Similarly, when the main body driver 1a acted outward, the springs 1y were extended to make the gas injection pipe fixing table 1s move outward along the transmission rods 1k, and the gas injection pipe fixing table 1s drived the gas injection pipe 11f to move outward, thereby driving the high-pressure capillary 1o to move outward.

In Raman detection, a stainless steel sheet was arranged at a position below a bottom visual window 1z. Reaction kettle fixing threaded rods 1q and a reaction kettle fixing block 11a were used for fixing a capillary reaction kettle 1 on an existing observation table of a laboratory Raman device.

Then a low-temperature circulation outlet pipe 13 was connected with an upper cover low-temperature circulation cavity inlet 11c, and a main body low-temperature circulation cavity outlet 1f was connected with a low-temperature circulation inlet pipe 14. A low-temperature constant-temperature tank 8 was turned on, the temperature of the capillary reaction kettle 1 was maintained at 2° C. and stabilized for 30 min, and then the experiment was started.

During the period, the temperature in the capillary reaction kettle 1 was observed through the temperature sensor 19, and the set temperature of the low-temperature constant-temperature tank 8 was adjusted to reach the temperature required by the experiment. Then high-pressure carbon dioxide gas was injected to generate a carbon dioxide hydrate sample. A gas cylinder 4 was opened, a pressure regulating gauge 5 was adjusted to a proper pressure, a first stop valve 6 was opened, a second stop valve 9 was closed, and the high-pressure carbon dioxide gas in the gas cylinder 4 was injected into a high-pressure plunger pump 7. After a certain time, the first stop valve 6 was closed, the second stop valve 9 was opened, the pressure value was set to maintain a t 3.5 MPa in a constant pressure mode.

After the pressure and the temperature were stable, a microscopic camera 3 was adjusted to a proper and clear shooting angle, a data recording module of a data acquisition computer 12 was turned on, and meanwhile, the temperature data and the image data were recorded. A third stop valve 10 was opened, and the high-pressure carbon dioxide gas was injected into the high-pressure capillary 1o. The indicated number of the pressure of the high-pressure plunger pump 7 was observed. After the pressure was stabilized at 3.5 MPa, the third stop valve 10, the second stop valve 9 and the high-pressure plunger pump 7 were closed. Finally, the growth process of the carbon dioxide hydrate crystals was subjected to Raman observation and was recorded.

In the link of crystal sample preparation and observation, the growth processes of the carbon dioxide hydrate crystals were the same in the Raman detection and the optical detection. There were three main differences: firstly, a stainless steel sheet was used in the Raman detection of the growth structure of the hydrate crystals, while a light source was needed in the optical detection, and the stainless steel sheet prevented Raman laser from penetrating through the hydrate crystals. Secondly, during the Raman detection, the capillary reaction kettle 1 needed to be fixed on the existing observation table of a laboratory Raman device by using the reaction kettle fixing threaded rods 1q, so as to ensure system stability; and during the optical detection, the capillary reaction kettle 1 was only required to be placed on the optical movable platform, and the light source was aligned with the visual windows. Thirdly, during the Raman detection, the microscopic camera 3 was self-carried by the Raman device and mainly finished shooting and acquisition of Raman spectrums of the structure of the hydrate crystals.

The above examples are only for illustrating the technical idea and features of the present disclosure, and the purpose is to make the those skilled in the art understand the content of the present disclosure and implement it, and not to limit the protection scope of the present disclosure by this. All equivalent changes or modifications made according to the essence of the content of the present disclosure should be covered in the protection scope of the present disclosure.

What is claimed is:

1. A device for optical observation and structural analysis of hydrate crystal growth, comprising a capillary reaction kettle, a gas injection system, a detection system, a temperature control system and a data acquisition system, wherein:
the capillary reaction kettle comprises a reaction kettle main body and a reaction kettle upper cover, and the reaction kettle upper cover is provided with an upper cover low-temperature circulation cavity;
the outer side of the reaction kettle main body adopts a main body low-temperature circulation cavity, and the interior of the reaction kettle main body comprises a transmission region and a capillary fixing region; a main body driver in the transmission region penetrates through the side wall of the reaction kettle main body and is connected with a gas injection pipe fixing table, the gas injection pipe fixing table is sleeved on one ends of transmission rods, the other ends of the transmission rods are fixed on a capillary fixing table, and springs are sleeved on outside of the t ransmission rods; and a gas injection pipe is fixed in a gas injection pipe fixation groove of the gas injection pipe fixing table through a gas injection pipe fixing pressing sheet;
in the capillary fixing region, the capillary fixing table and an internal low-temperature circulation cavity are fixed on the reaction kettle main body, one end of a high-pressure capillary is a sealed end, the other end of the high-pressure capillary is an open end connected to the gas injection pipe;
the open end is supported by a fixing table clamping groove of the capillary fixing table, the sealed end is pressed in a circulation cavity clamping groove through a capillary visual pressing sheet fixed in the internal low-temperature circulation cavity, and the capillary visual pressing sheet is provided with an observation notch for observing the high-pressure capillary;
when the main body driver enables the gas injection pipe fixing table to move, the gas injection pipe moves along with the gas injection pipe fixing table, such that the high-pressure capillary moves in the fixing table clamping groove and the circulation cavity clamping groove;
the reaction kettle upper cover and the reaction kettle main body are both provided with visual windows for light transmission or observation, and the high-pressure capillary at theobservation notch is located in a light transmission or observation region of the visual window;
the gas injection system is connected to the high-pressure capillary of the capillary reaction kettle;
the detection system is used for performing Raman detection or optical detection of the capillary reaction kettle; and
the temperature control system communicates with the upper cover low-temperature circulation cavity, the main body low-temperature circulation cavity and the internal low-temperature circulation cavity of the capillary reaction kettle.

2. The device for optical observation and structural analysis of hydrate crystal growth according to claim 1, wherein:
a low-temperature circulation outlet pipe of a low-temperature constant-temperature tank in the temperature control system is connected to the upper cover low-temperature circulation cavity through an upper cover low-temperature circulation cavity inlet, an upper cover low-temperature circulation cavity outlet is connected to the main body low-temperature circulation cavity through a main body low-temperature circulation cavity inlet, a main body low-temperature circulation cavity outlet is connected to the internal low-temperature circulation cavity through an internal low-temperature circulation cavity main inlet and an internal low-temperature circulation cavity inlet in sequence; and an internal low-temperature circulation cavity outlet is connected with an internal low-temperature circulation cavity main outlet and then connected back to the low-temperature constant-temperature tank through a low-temperature circulation inlet pipe.

3. The device for optical observation and structural analysis of hydrate crystal growth according to claim 1, wherein the gas injection system comprises a gas cylinder, which is connected to a high-pressure plunger pump through a pressure regulating gauge and a first stop valve, and a high-pressure pipeline of the high-pressure plunger pump is provided with a second stop valve and a third stop valve; and the tail end of the high-pressure pipeline is the gas injection pipe connected with the high-pressure capillary.

4. The device for optical observation and structural analysis of hydrate crystal growth according to claim 1, wherein the temperature control system comprises a low-temperature constant-temperature tank, a low-temperature circulation inlet pipe and a low-temperature circulation outlet pipe; and the low-temperature circulation inlet pipe is connected with an internal low-temperature circulation cavity main outlet, and a low-temperature circulation outlet pipe is connected with an upper cover low-temperature circulation cavity inlet.

5. The device for optical observation and structural analysis of hydrate crystal growth according to claim 1, wherein the detection system comprises a microscopic camera, a camera support, a detection auxiliary part and an optical movable platform; the detection auxiliary part, the microscopic camera and the camera support are all arranged on the optical movable platform; and
the detection auxiliary part adopts a stainless steel sheet during Raman detection, and the detection auxiliary part adopts a light source during optical detection.

6. The device for optical observation and structural analysis of hydrate crystal growth according to claim 1, wherein the data acquisition system comprises an image acquisition system and a temperature acquisition system, and a microscopic camera in the image acquisition system is connected to a data acquisition computer through a camera transmission line; and a temperature sensor in the temperature acquisition system is connected to the data acquisition computer through a data acquisition box.

7. The device for optical observation and structural analysis of hydrate crystal growth according to claim 1, wherein a top visual window is fixed on the reaction kettle upper cover through a top visual window fixing ring, and a bottom visual window is fixed on the reaction kettle main body through a bottom visual window fixing ring.

8. The device for optical observation and structural analysis of hydrate crystal growth according to claim 1, wherein the reaction kettle upper cover of the capillary reaction kettle is fixed with the reaction kettle main body through bolts, and a polytetrafluoroethylene sealing ring is arranged in a sealing ring placing notch in the reaction kettle main body.

9. The device for optical observation and structural analysis of hydrate crystal growth according to claim 1, wherein the bottom of the reaction kettle main body is provided with a reaction kettle fixing block fixed on the optical movable platform during Raman detection, and the reaction kettle fixing block is provided with reaction kettle fixing threaded rods, and number of the reaction kettle fixing threaded rods is four.
